(19) United States
(12) Patent Application Publication
(10) Pub. No.: US 2010/0151732 A1
(43) Pub. Date: Jun. 17, 2010

(54) SHIELDED ELECTRICAL CONNECTOR

(75) Inventors: BIN XU, Kunshan (CN); SU-FENG LIU, Kunshan (CN); CHIN-TE LAI, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/635,719

(22) Filed: Dec. 11, 2009

(30) Foreign Application Priority Data
Dec. 11, 2008 (CN) 200810306119.6

(51) Int. Cl. H01R 9/03

(52) U.S. Cl. 439/607.45; 439/607.46

(57) ABSTRACT

An electrical connector (100) includes an inner shielding member (3) having a first shielding part (31) and a second shielding part (32), both first shielding part and the second shielding part having a similar main portion; a printed circuit board (4) with side portions thereof being sandwiched between the first shielding part and the second shielding part; a plug port (5) disposed in front of the printed circuit board; and an external cover (2) mounted to the inner shielding member, with the plug port extending into an opening defined in the external cover.

### BACKGROUND OF THE INVENTION

1. Field of the Invention

The present invention generally relates to an electrical connector, and more particularly to an electrical connector with shielding members.

2. Description of Related Art

TW patent No. 371527 issued on Oct. 1, 1999 to Kuo discloses a kind of electrical connector. The electrical connector includes an insulated housing with a number of contacts received therein, a pair of metallic shielding members enclosing the insulated housing, and a pair of external cover mounted to the pair of metallic shielding members. The metallic shielding members can protect signals transmitted through the contacts away from external Electromagnetic Interference (EMI). However, the metallic shielding members are of different shape, and two different tools or different manufacturing process are need to make such metallic shielding members, therefore, manufacturing cost is relatively high.

Hence, an improved electrical connector is highly desired to overcome the disadvantages of the related art.

### SUMMARY OF THE INVENTION

Accordingly, an object of the present invention is to provide a shielded electrical connector.

In order to achieve the object set forth, an electrical connector in accordance with the present invention comprises an inner shielding member having a first shielding part and a second shielding part, both first shielding part and the second shielding part having a similar main portion; a printed circuit board with side portions thereof being sandwiched between the first shielding part and the second shielding part; a plug port disposed in front of the printed circuit board; and an external cover mounted to the inner shielding member, with the plug port extending into an opening defined in the external cover.

Other objects, advantages and novel features of the invention will become more apparent from the following detailed description when taken in conjunction with the accompanying drawings.

### BRIEF DESCRIPTION OF THE DRAWINGS

FIG. 1 is an assembled, perspective view of an electrical connector;

FIG. 2 is a partially assembled, perspective view of the electrical connector;

FIG. 3 is an exploded, perspective view of the electrical connector; and

FIG. 4 is a view similar to FIG. 3, but viewed from another aspect.

### DETAILED DESCRIPTION OF THE INVENTION

Reference will now be made in detail to the preferred embodiment of the present invention.

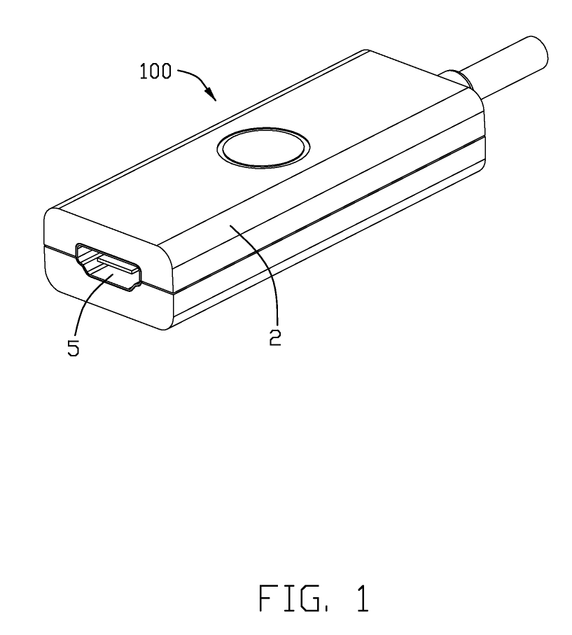

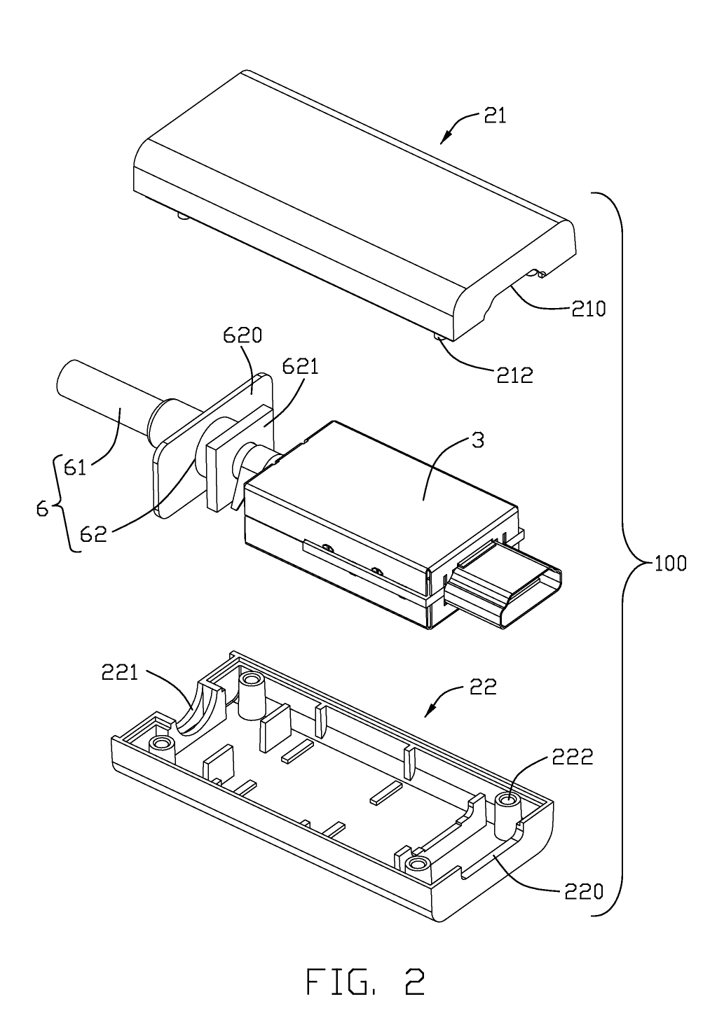

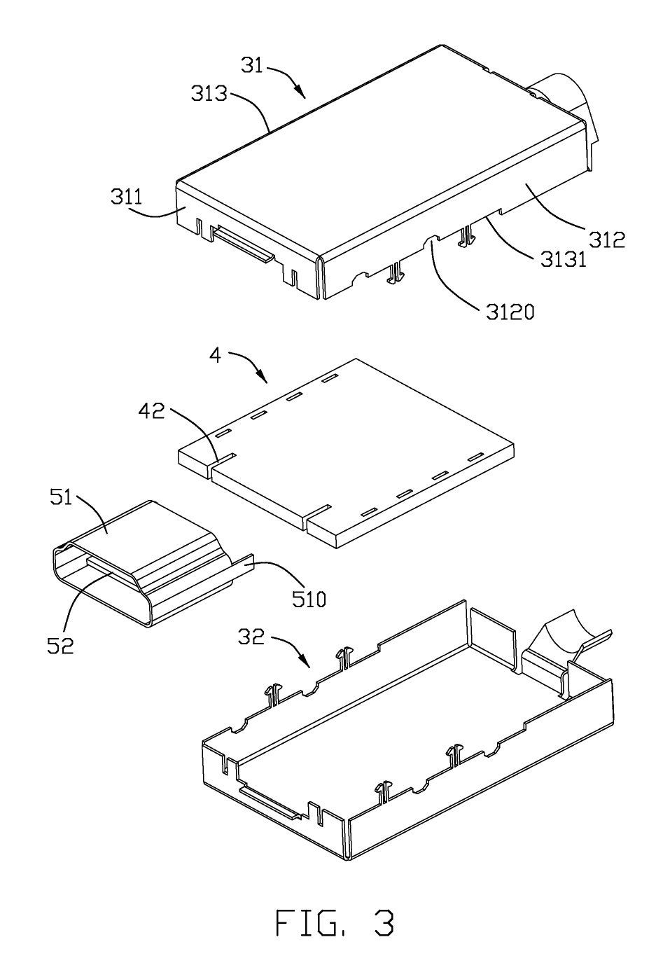

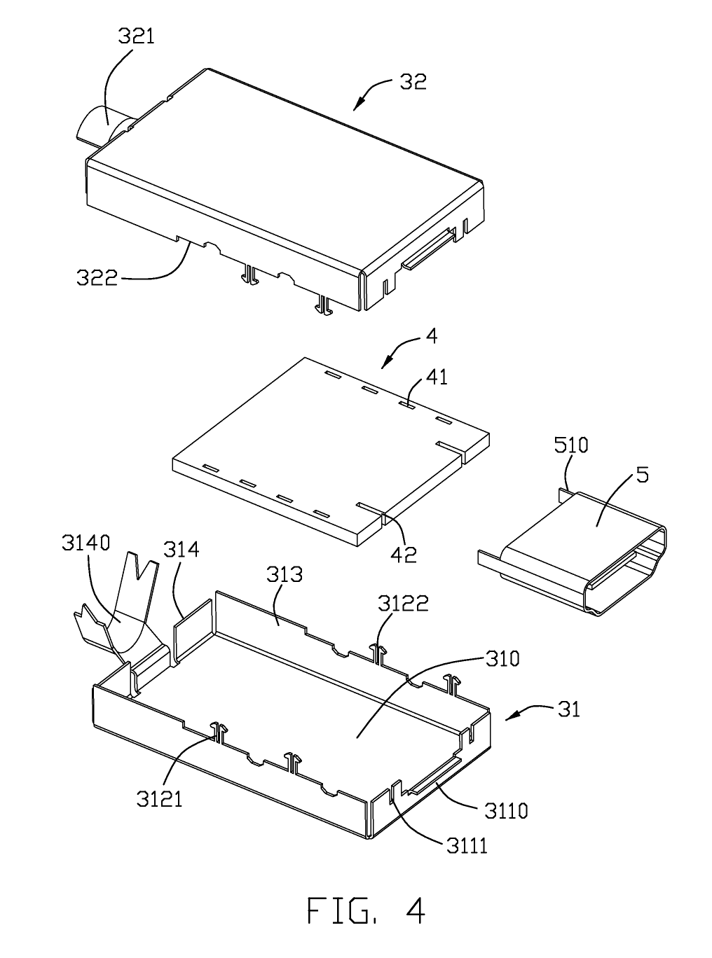

Referring to FIGS. 1-4, an electrical connector 100 in accordance with the present invention includes an external cover 2, an inner shielding member 3, a printed circuit board 4, a plug port 5. The electrical connector 100 is adapted to be terminated to a cable 6 to form a cable assembly.

The printed circuit board 4 is of rectangular shaped. The printed circuit board 4 includes a front portion and an opposite rear portion. A number of holes 41 are defined in two side portions of the printed circuit board 4, respectively. Two slots 42 are defined in the front portion thereof The printed circuit board 4 may further has a number of conductive pads (not shown) formed on the front portion and the rear portion thereof

The inner shielding member 3 includes a first shielding part (upper shielding member) 31 and a second shielding part (lower shielding member) 32. The first shielding part 31 has main portion which includes a top side 310, a front side 311 and a rear side 314 respectively extend from front and rear edges of the top side 310, a pair of lateral sides 312, 313 extend from lateral edges of the top side 310. A middle portion of the front side 311 is cut and bent forwardly to form a supporting portion 3110, with a front opening (not numbered) defined therein. Two slits 3111 are defined in lateral portions of the front side 311 and arranged at opposite sides of the supporting portion 3110. Two cutouts 3120 are respectively defined in a lower portion of the pair of lateral sides 312, 313, and two locking members 3121 project downwardly from a bottom edge of the pair of the lateral sides 312, 313, respectively. The cutouts 3120 and the locking members 3121 are alternately disposed along the lateral sides 312, 313. Each locking member 3121 has two hooks (not number) arranged in back-to-back manner, with a gap 3122 therebetween. The front segment of the lower portion of the lateral wall 312/313 is cut off to form an elongated notch 3131. The notch 3131 has same length with the printed circuit board 4. A cable holder 3140 is formed on the rear side and extends backwardly therefrom. The second shielding part 32 has a main portion which is similar to the main portion of the first shielding part 3, except for contour/configuration of a cable holder 321 thereof and the cable holder 3140.

The plug port 5 includes an insulated housing 52, a metal shell 51 enclosing the insulated housing 52. The plug port 5 is located in front of the printed circuit board 4, with two arms 510 extending from lateral sides of the metal shell 51 and into the two slots 42 of the printed circuit board 4. The two arms 510 are further soldered with the printed circuit board 4. The plug port 5 may has a number of contacts (not shown) supported by the insulated housing 52 and further soldered to corresponding conductive pads formed on the front portion of the printed circuit board 4.

The cable 6 has a front portion 61 with wires (not shown) thereof being terminated to conductive pads formed at the back portion of the printed circuit board 4. Further more, the cable 6 may be equipped with a strain relief member 62 molded over the front portion 61. The strain relief member 62 has a positioning portion 620 and a stopping portion 621. The stopping portion 621 smaller than the portioning portion 620 and disposed in front of the positioning portion 620.

The inner shielding member 3 is mounted to the printed circuit board 4, with the side portions of the printed circuit board 4 is accommodated in and sandwiched between the notches 3131 of the first shielding part 31 and the second shielding part 32. The locking members 3121 of the first shielding part 31 locked into the holes 41 of the printed circuit board 4 and extend into the cutouts 3120 of the second shielding part 32, while the locking members 3121 of the second shielding part 32 locked into the holes 41 of the printed circuit board 4 and extend into the cutouts 3120 of the first shielding part 31. Therefore, the first shielding part 31 and the second shielding part 32 are both combined with the printed circuit board 4. The metal shell 51 of the plug port 5 is held in the front opening of the in shielding member 3. The supporting portions 3110 of the first shielding part 31 and the second shielding part 32 corporately sandwich a rear segment of the metal shell 51, and the arms 510 insert into the shielding member 3 via the slits 3111 thereof.

The external cover 2 includes a first cover 21 and a second cover 22. A semi-circular shaped cable exiting opening 221 is defined in a rear wall of the first cover 21, and the second cover 22 also has a similar cable exiting opening defined in a rear wall thereof, therefore a circular shaped cable exiting opening is formed by the two semi-circular shaped cable exiting opening to retain the cable 6. A trapezoidal opening 210 is defined in a front wall of the first cover 21. A U-shaped opening 220 is defined in a front wall of a second cover 22. Four positioning posts 212 are arranged at corners in an interior of the first cover 21, and corresponding four positioning cavities 222 are located in an interior of the second cover 22. The positioning posts 212 can be inserted into the positioning cavities 222. Two boards (not numbered) respectively arranged in the interior of the first cover 21 and the second cover 22. The two boards are spaced from each other and located adjacent to the rear walls of the both the first cover 21 and the second cover 22.

The first cover 21 and the second cover 22 are assembled to the outside of the inner shielding member 3, with the metal shell 51 projecting outward via the openings 210, 220, the two boards interposed between the positioning portion 620 and the stopping portion 621, the cable 6 extending outside of the first cover 21 and the second cover 22 via the cable exiting opening. The first cover 21 and the second cover 22 are combined together by the positioning posts 221 and the positioning cavities 222.

It is to be understood, however, that even though numerous characteristics and advantages of the present invention have been set forth in the foregoing description, together with details of the structure and function of the invention, the disclosure is illustrated only, and changes may be made in detail, especially in matters of shape, size, and arrangement of parts within the principles of the invention to the full extent indicated by the broad general meaning of the terms in which the appended claims are expressed.

What is claimed is:

1. An electrical connector, comprising:
an inner shielding member having a first shielding part and a second shielding part, each of the first shielding part and the second shielding part having a main portion;
a printed circuit board having side portions sandwiched between the first shielding part and the second shielding part;
a plug port disposed in front of the printed circuit board; and
an external cover mounted to the inner shielding member, with the plug port extending into an opening defined in the external cover.

2. The electrical connector as claimed in claim 1, wherein the first shielding part has two lateral sides and two locking members respectively extending downwardly from the two lateral sides and inserted into holes defined in the side portions of the printed circuit board.

3. The electrical connector as claimed in claim 2, wherein two cutouts are defined in two lateral sides of the second shielding part receiving ends of the two locking members of the first shielding part.

4. The electrical connector as claimed in claim 3, wherein the second shielding part has two lateral sides and two locking members respectively extending upwardly from the two lateral sides and inserted into holes defined in the side portions of the printed circuit board.

5. The electrical connector as claimed in claim 4, wherein two cutouts are defined in two lateral sides of the first shielding part receiving ends of the two locking members of the second shielding part.

6. The electrical connector as claimed in claim 5, wherein the locking members and cutouts are alternately arranged along each lateral side of inner shielding member.

7. The electrical connector as claimed in claim 1, wherein the first shielding part and the second shielding part respectively define two notches in two lateral sides thereof, and the side portions of the printed circuit board are accommodated in the notches.

8. The electrical connector as claimed in claim 1, wherein the plug port includes a metal shell and an insulated housing enclosed within the metal shell.

9. The electrical connector as claimed in claim 8, wherein two arms extend rearwardly from the metal shell and into slots defined in a front portion of the printed circuit board.

10. The electrical connector as claimed in claim 9, wherein the two arms are soldered to the printed circuit board.

11. The electrical connector as claimed in claim 8, wherein the plug port is held in a front opening defined in a front side of the inner shielding member.

12. The electrical connector as claimed in claim 11, wherein two supporting portions project forwardly from upper and lower edges of the front opening, and the plug port is sandwiched between the two supporting portions.

13. An electrical cable connector assembly comprising:
an internal printed circuit board defining opposite first and second surfaces thereof;
a metallic shell secure to the printed circuit board and essentially covering wholly at least one of said first and second surfaces;
an electrical connector mechanically and electrically connected around a front region of the printed circuit board;
a cable electrically and mechanically connected around a rear region of the printed circuit board; and
an insulative cover enclosing said shell and the other of said first and second surfaces and further defining front and rear opening through which the connector and the cable respectively extend outwardly in opposite directions.

14. The cable connector assembly as claimed in claim 13, wherein said shell defines a rear end grasping the cable.

15. The cable connector assembly as claimed in claim 13, wherein said shell defines an abutment flange mechanically and electrically engaged with a shield of the electrical connector.

16. The cable connector assembly as claimed in claim 13, further including another metallic shell located between the other of said first and second surfaces and the cover and essentially covering wholly the other of the first and second surfaces.

17. The cable connector assembly as claimed in claim 16, wherein said another shell defines a section engaged with either a shield of the connector or the cable.

18. The cable connector assembly as claimed in claim 17, wherein the connector is located at a same level with the internal printed circuit board.

19. A cable connector assembly comprising:
an internal printed circuit board;
a metallic shell device enclosing said printed circuit board;
an insulative cover enclosing said shell;
an electrical connector essentially located in front of and at a same level with the printed circuit board; and
a cable extending rearwardly from and essentially located at said same level with the printed circuit board; wherein
said shell defines a front section mechanically and electrically engaged with a shield of the connector, and a rear section mechanically and electrically engaged with the cable.

20. The cable connector assembly as claimed in claim 19, wherein said printed circuit board defines a pair of slits to receive two opposite arms rearwardly extending from the shield of the connector for positioning the connector with regard to the printed circuit board.
